(19) United States
(12) Patent Application Publication
(10) Pub. No.: US 2016/0309469 A1
(43) Pub. Date: Oct. 20, 2016

(54) DATA TRANSMISSION METHOD AND APPARATUS

(71) Applicant: HUAWEI DEVICE CO., LTD., Shenzhen (CN)

(72) Inventors: Guiming SHU, Shenzhen (CN); Zhigang RONG, Shenzhen (CN); Su LU, Shenzhen (CN); Zhiming DING, Shenzhen (CN); Zhenguo DU, Shenzhen (CN)

(21) Appl. No.: 15/103,776

(22) PCT Filed: Dec. 12, 2013
(86) PCT No.: PCT/CN2013/089274

§ 371 Date: Jun. 10, 2016

(51) Int. Cl. H04W 72/04; H04W 56/00; H04W 48/12; H04L 27/26

(52) U.S. Cl. CPC H04W 72/0446; H04L 27/2602; H04W 56/0015; H04W 48/12; H04W 84/12

(57) ABSTRACT

The present invention provides a data transmission method and apparatus. The method includes: sending, by an access point, channel opportunity information, so that stations that have data to be sent randomly select, after receiving the channel opportunity information, a channel opportunity from the channel opportunity information, and concurrently send a sending request message to the access point; allocating, by the access point according to the received sending request message, to a station that sends the received sending request message, a channel resource that is used for sending uplink data; and sending, by the access point according to the allocated channel resource, a sending acknowledgement message to the station that sends the received sending request message, so that stations that receive the sending acknowledgement message use channel resources to concurrently send uplink data. Therefore, a synchronization requirement that multiple stations use different subcarriers to concurrently send data can be well met.

### TECHNICAL FIELD

Embodiments of the present invention relate to the field of communications technologies, and in particular, to a data transmission method and apparatus.

### BACKGROUND

In a wireless local area network (Wireless local access network, WLAN for short) that complies with the orthogonal frequency division multiplexing (Orthogonal frequency division multiplexing, OFDM for short) standard, a mechanism that is stipulated in a current standard and by using which a station (STA) sends data to an access point (Access Point, AP for short) is: multiple STAs share one channel, and the multiple STAs occupy the entire channel within a period of time by means of a contention mechanism to send data to an AP. Apparently, in the foregoing mechanism, channel resource usage is very low.

To improve channel resource usage, an existing optimized solution for a mechanism of data transmission between a STA and an AP based on a request to send (Request To Send, RTS for short) frame/a clear to send (Clear to send, CTS for short) frame is as follows: An AP divides in advance a channel into four subchannels, where each subchannel includes four subcarriers; after simultaneously detecting that a channel idle time exceeds a time of one data interframe space (Data interframe space, DIFS for short), multiple different STAs that need to send data separately and randomly select one subchannel, randomly select one subcarrier from each subchannel selected by the STAs, and concurrently send RTS to the AP, where the RTS does not include Media Access (MAC) layer data, and the STAs use the RTS to indicate to the AP that there is uplink data to be sent; and if the AP allows a STA to send data, the AP sends CTS on a corresponding subcarrier on which the STA has sent RTS, so as to indicate to the STA that a subchannel on which the subcarrier is located is used by the STA. In this way, multiple stations can concurrently send, on different subchannels, data to an AP after obtaining, by means of an RTS/CTS mechanism, permission to use the different subchannels.

However, such an existing optimized mechanism has the following problem: Synchronization of times at which multiple STAs concurrently send RTS is ensured by a case in which the multiple STAs simultaneously detect that a channel is idle; however, because surrounding wireless channel environments of different STAs are significantly different, it is very difficult to meet, by means of such synchronization of times, a synchronization requirement that multiple STAs use different subcarriers to concurrently send data.

### SUMMARY

Embodiments of the present invention provide a data transmission method and apparatus, which can well meet a synchronization requirement that multiple stations use different subcarriers to concurrently send data.

According to a first aspect, an embodiment of the present invention provides a data transmission method, including:

sending, by an access point, channel opportunity information, where the channel opportunity information includes at least one channel opportunity, and the channel opportunity is a subchannel that can be used by a station to send a sending request message to the access point, and a corresponding subchannel usage time;

allocating, by the access point according to the received sending request message, to the station that sends the received sending request message, a channel resource that is used for sending uplink data; and

sending, by the access point according to the allocated channel resource, a sending acknowledgement message to the station that sends the received sending request message, so that stations that receive the sending acknowledgement message use the channel resource to concurrently send uplink data.

In a first possible implementation manner of the first aspect, the sending, by an access point, channel opportunity information includes:

sending, by the access point, a beacon frame, where the beacon frame includes the channel opportunity information.

With reference to the first aspect, in a second possible implementation manner of the first aspect, the sending, by an access point, channel opportunity information includes:

sending, by the access point, an uplink synchronization indication message, where the uplink synchronization indication message includes the channel opportunity information.

With reference to the second possible implementation manner of the first aspect, in a third possible implementation manner of the first aspect, before the sending, by the access point, an uplink synchronization indication message, the method further includes:

sending, by the access point, a beacon frame, where the beacon frame includes a sending time at which the access point sends the uplink synchronization indication message within a current beacon period, so that a station that has data to be sent maintains an awake state at the time at which the uplink synchronization indication message is sent, and receives the uplink synchronization indication message.

With reference to the second possible implementation manner of the first aspect or the third possible implementation manner of the first aspect, in a fourth possible implementation manner of the first aspect, the uplink synchronization indication message further includes station indication information, where the station indication information includes an identifier of a station that is allowed to send a sending request message, and the station indication information is used by a station that has data to be sent, to determine, after receiving the uplink synchronization indication message, that a sending request message can be sent to the access point.

With reference to the method according to any one of the first aspect to the fourth possible implementation manner of the first aspect, in a fifth possible implementation manner of the first aspect, the sending request message includes channel usage time information that is needed to send uplink data by the station that sends the sending request message or volume information of uplink data to be sent by the station that sends the sending request message, and the allocating, by the access point according to the received sending request message, to the station that sends the received sending request message, a channel resource that is used for sending uplink data includes:

allocating, by the access point according to the channel usage time information that is needed by the station to send the uplink data or the volume information of the uplink data to be sent by the station, where the information is included in the received sending request message, to the station that sends the received sending request message, a subchannel used for sending uplink data; and

the sending, by the access point according to the allocated channel resource, a sending acknowledgement message to the station that sends the received sending request message includes:

sending, by the access point by using the subchannel allocated to the station, the sending acknowledgement message to the station that sends the received sending request message.

With reference to the method according to any one of the first aspect to the fourth possible implementation manner of the first aspect, in a sixth possible implementation manner of the first aspect, the allocating, by the access point according to the received sending request message, to the station that sends the received sending request message, a channel resource that is used for sending uplink data includes:

allocating, by the access point according to the received sending request message, one or more subchannels that are used for sending uplink data, and a corresponding channel usage time to the station that sends the received sending request message; and

the sending, by the access point according to the allocated channel resource, a sending acknowledgement message to the station that sends the received sending request message includes:

sending, by the access point by using the one or more subchannels that are used for sending uplink data and that are allocated to the station that sends the received sending request message, the sending acknowledgement message to the station that sends the received sending request message, where the sending acknowledgement message includes the one or more subchannels that are used for sending uplink data and that are allocated to the station that sends the received sending request message, and the corresponding channel usage time.

With reference to the method according to any one of the first aspect to the fourth possible implementation manner of the first aspect, in a seventh possible implementation manner of the first aspect, the sending request message includes subchannel indication information that is used to send uplink data by the station that sends the sending request message, and the allocating, by the access point according to the received sending request message, to the station that sends the received sending request message, a channel resource that is used for sending uplink data includes:

allocating, by the access point according to the subchannel indication information included in the received sending request message, one or more subchannels that are used for sending uplink data, and a corresponding channel usage time to the station that sends the received sending request message; and

the sending, by the access point according to the allocated channel resource, a sending acknowledgement message to the station that sends the received sending request message includes:

sending, by the access point by using the one or more subchannels that are used for sending uplink data and that are allocated to the station that sends the received sending request message, the sending acknowledgement message to the station that sends the received sending request message, where the sending acknowledgement message includes the one or more subchannels that are used for sending uplink data and that are allocated to the station that sends the received sending request message, and the corresponding channel usage time.

With reference to the seventh possible implementation manner of the first aspect, in an eighth possible implementation manner of the first aspect, a transmit address field of the sending request message includes association identifier information of the station that sends the sending request message, and the subchannel indication information.

With reference to the method according to any one of the sixth possible implementation manner of the first aspect to the eighth possible implementation manner of the first aspect, in a ninth possible implementation manner of the first aspect, a receive address field of the sending acknowledgement message includes association identifier information of the station that receives the sending acknowledgement message, one or more subchannels that are used for sending uplink data and that are allocated by the access point to the station that receives the sending acknowledgement message, and corresponding channel usage time information.

With reference to the method according to any one of the first aspect to the ninth possible implementation manner of the first aspect, in a tenth possible implementation manner of the first aspect, a duration field of the sending request message includes at least channel usage time information that is needed to send uplink data by the station that has data to be sent, so that another station that receives the sending request message sets a network allocation vector time value according to the channel usage time information, and no longer contends for a channel within a corresponding network allocation vector time.

With reference to the method according to any one of the first aspect to the tenth possible implementation manner of the first aspect, in an eleventh possible implementation manner of the first aspect, the method further includes:

concurrently sending, by the access point after receiving the uplink data that is sent by the station that receives the sending acknowledgement message, an acknowledgement message to stations that send the received uplink data.

With reference to the eleventh possible implementation manner of the first aspect, in a twelfth possible implementation manner of the first aspect, the concurrently sending, by the access point after receiving the uplink data that is sent by the station that receives the sending acknowledgement message, an acknowledgement message to stations that send the received uplink data includes:

concurrently sending, by the access point, on one of subchannels used when the station sends the uplink data, or on a corresponding subchannel on which the station sends the sending request message, the acknowledgement message to the stations that send the received uplink data.

According to a second aspect, an embodiment of the present invention provides a data transmission method, including:

receiving, by a station, channel opportunity information sent by an access point, where the channel opportunity information includes at least one channel opportunity, and the channel opportunity is a subchannel that can be used by the station to send a sending request message to the access point, and a corresponding subchannel usage time;

randomly selecting, by the station, a channel opportunity from the channel opportunity information, and sending the sending request message to the access point, so that the access point allocates, according to the received sending request message, to the station that sends the received sending request message, a channel resource that is used for sending uplink data, and sends, according to the allocated channel resource, a sending acknowledgement message to the station that sends the received sending request message; and

sending, by the station after receiving the sending acknowledgement message, uplink data by using the allocated channel resource.

In a first possible implementation manner of the second aspect, the receiving, by a station, channel opportunity information sent by an access point includes:

receiving, by the station, a beacon frame sent by the access point, where the beacon frame includes the channel opportunity information.

With reference to the second aspect, in a second possible implementation manner of the second aspect, the receiving, by a station, channel opportunity information sent by an access point includes:

receiving, by the station, an uplink synchronization indication message sent by the access point, where the uplink synchronization indication message includes the channel opportunity information.

With reference to the second possible implementation manner of the second aspect, in a third possible implementation manner of the second aspect, before the receiving, by the station, an uplink synchronization indication message sent by the access point, the method further includes:

receiving, by the station, a beacon frame sent by the access point, where the beacon frame includes a sending time at which the access point sends the uplink synchronization indication message within a current beacon period; and

maintaining, by the station, an awake state at the time at which the uplink synchronization indication message is sent, and receiving the uplink synchronization indication message that is sent by the access point at the sending time.

With reference to the second possible implementation manner of the second aspect or the third possible implementation manner of the second aspect, in a fourth possible implementation manner of the second aspect, the uplink synchronization indication message further includes station indication information, where the station indication information includes an identifier of a station that is allowed to send a sending request message, and the randomly selecting, by the station, a channel opportunity from the channel opportunity information, and sending the sending request message to the access point includes:

after determining, according to the station indication information, that the sending request message can be sent to the access point, randomly selecting, by the station, a channel opportunity from the channel opportunity information, and sending the sending request message to the access point.

With reference to the method according to any one of the second aspect to the fourth possible implementation manner of the second aspect, in a fifth possible implementation manner of the second aspect, the sending request message includes channel usage time information that is needed to send uplink data by the station that sends the sending request message or volume information of uplink data to be sent by the station that sends the sending request message, so that the access point allocates, according to the channel usage time information that is needed by the station to send the uplink data or the volume information of the uplink data to be sent by the station, where the information is included in the received sending request message, to the station that sends the received sending request message, a subchannel used for sending uplink data, and sends, by using the allocated subchannel, the sending acknowledgement message to the station that sends the received sending request message.

With reference to the method according to any one of the second aspect to the fourth possible implementation manner of the second aspect, in a sixth possible implementation manner of the second aspect, the sending request message includes subchannel indication information that is used to send uplink data by the station that sends the sending request message, so that the access point allocates, according to the subchannel indication information included in the received sending request message, one or more subchannels that are used for sending uplink data, and a corresponding channel usage time to the station that sends the received sending request message, and sends the sending acknowledgement message to the station by using the one or more subchannels that are used for sending uplink data and that are allocated to the station that sends the received sending request message, where the sending acknowledgement message includes the one or more subchannels that are used for sending uplink data and that are allocated to the station that sends the received sending request message, and the corresponding channel usage time.

With reference to the sixth possible implementation manner of the second aspect, in a seventh possible implementation manner of the second aspect, a transmit address field of the sending request message includes association identifier information of the station that sends the sending request message, and the subchannel indication information.

With reference to the sixth possible implementation manner of the second aspect or the seventh possible implementation manner of the second aspect, in an eighth possible implementation manner of the second aspect, a receive address field of the sending acknowledgement message includes association identifier information of the station that receives the sending acknowledgement message, one or more subchannels that are used for sending uplink data and that are allocated by the access point, and corresponding channel usage time information.

With reference to the method according to any one of the second aspect to the eighth possible implementation manner of the second aspect, in a ninth possible implementation manner of the second aspect, a duration field of the sending request message includes at least channel usage time information that is needed to send uplink data by the station that has data to be sent, so that another station that receives the sending request message sets a network allocation vector time value according to the channel usage time information, and no longer contends for a channel within a corresponding network allocation vector time.

With reference to the method according to any one of the second aspect to the ninth possible implementation manner of the second aspect, in a tenth possible implementation manner of the second aspect, the method further includes:

receiving, by the station, an acknowledgement message that is sent by the access point after the access point receives the uplink data.

According to a third aspect, an embodiment of the present invention provides an access point, including:

a sending module, configured to send channel opportunity information, where the channel opportunity information includes at least one channel opportunity, and the channel opportunity is a subchannel that can be used by a station to send a sending request message to the access point, and a corresponding subchannel usage time;

a receiving module, configured to receive the sending request message sent by the station; and

an allocation module, configured to allocate, according to the received sending request message, to the station that sends the received sending request message, a channel resource that is used for sending uplink data, where

the sending module is further configured to send, according to the allocated channel resource, a sending acknowledgement message to the station that sends the received sending request message, so that stations that receive the sending acknowledgement message use the channel resource to concurrently send uplink data.

In a first possible implementation manner of the third aspect, the sending channel opportunity information includes:

sending a beacon frame, where the beacon frame includes the channel opportunity information.

With reference to the third aspect, in a second possible implementation manner of the third aspect, the sending channel opportunity information includes:

sending an uplink synchronization indication message, where the uplink synchronization indication message includes the channel opportunity information.

With reference to the second possible implementation manner of the third aspect, in a third possible implementation manner of the third aspect, before sending the uplink synchronization indication message, the sending module is further configured to:

send a beacon frame, where the beacon frame includes a sending time at which the access point sends the uplink synchronization indication message within a current beacon period, so that a station that has data to be sent maintains an awake state at the time at which the uplink synchronization indication message is sent, and receives the uplink synchronization indication message.

With reference to the second possible implementation manner of the third aspect or the third possible implementation manner of the third aspect, in a fourth possible implementation manner of the third aspect, the uplink synchronization indication message further includes station indication information, where the station indication information includes an identifier of a station that is allowed to send a sending request message, and the station indication information is used by a station that has data to be sent, to determine, after receiving the uplink synchronization indication message, that a sending request message can be sent to the access point.

With reference to the method according to any one of the third aspect to the fourth possible implementation manner of the third aspect, in a fifth possible implementation manner of the third aspect, the sending request message includes channel usage time information that is needed to send uplink data by the station that sends the sending request message or volume information of uplink data to be sent by the station that sends the sending request message, and the allocating, according to the received sending request message, to the station that sends the received sending request message, a channel resource that is used for sending uplink data includes:

allocating, according to the channel usage time information that is needed by the station to send the uplink data or the volume information of the uplink data to be sent by the station, where the information is included in the received sending request message, to the station that sends the received sending request message, a subchannel used for sending uplink data; and

the sending, according to the allocated channel resource, a sending acknowledgement message to the station that sends the received sending request message includes:

sending, by using the subchannel allocated to the station, the sending acknowledgement message to the station that sends the received sending request message.

With reference to the method according to any one of the third aspect to the fourth possible implementation manner of the third aspect, in a sixth possible implementation manner of the third aspect, the allocating, according to the received sending request message, to the station that sends the received sending request message, a channel resource that is used for sending uplink data includes:

allocating, according to the received sending request message, one or more subchannels that are used for sending uplink data, and a corresponding channel usage time to the station that sends the received sending request message; and

the sending, according to the allocated channel resource, a sending acknowledgement message to the station that sends the received sending request message includes:

sending, by using the one or more subchannels that are used for sending uplink data and that are allocated to the station that sends the received sending request message, the sending acknowledgement message to the station that sends the received sending request message, where the sending acknowledgement message includes the one or more subchannels that are used for sending uplink data and that are allocated to the station that sends the received sending request message, and the corresponding channel usage time.

With reference to the method according to any one of the third aspect to the fourth possible implementation manner of the third aspect, in a seventh possible implementation manner of the third aspect, the sending request message includes subchannel indication information that is used by the station to send uplink data, and the allocating, according to the received sending request message, to the station that sends the received sending request message, a channel resource that is used for sending uplink data includes:

allocating, according to the subchannel indication information included in the received sending request message, one or more subchannels that are used for sending uplink data, and a corresponding channel usage time to the station that sends the received sending request message; and

the sending, according to the allocated channel resource, a sending acknowledgement message to the station that sends the received sending request message includes:

sending, by using the one or more subchannels that are used for sending uplink data and that are allocated to the station that sends the received sending request message, the sending acknowledgement message to the station that sends the received sending request message, where the sending acknowledgement message includes the one or more subchannels that are used for sending uplink data and that are allocated to the station that sends the received sending request message, and the corresponding channel usage time.

With reference to the seventh possible implementation manner of the third aspect, in an eighth possible implementation manner of the third aspect, a transmit address field of the sending request message includes association identifier information of the station that sends the sending request message, and the subchannel indication information.

With reference to the method according to any one of the sixth possible implementation manner of the third aspect to the eighth possible implementation manner of the third aspect, in a ninth possible implementation manner of the third aspect, a receive address field of the sending acknowledgement message includes association identifier information of the station that receives the sending acknowledgement message, one or more subchannels that are used for sending uplink data and that are allocated by the access point to the station that receives the sending acknowledgement message, and corresponding channel usage time information.

With reference to the method according to any one of the third aspect to the ninth possible implementation manner of the third aspect, in a tenth possible implementation manner of the third aspect, a duration field of the sending request message includes at least channel usage time information that is needed to send uplink data by the station that has data to be sent, so that another station that receives the sending request message sets a network allocation vector time value according to the channel usage time information, and no longer contends for a channel within a corresponding network allocation vector time.

With reference to the method according to any one of the third aspect to the tenth possible implementation manner of the third aspect, in an eleventh possible implementation manner of the third aspect, the sending module is further configured to:

after the receiving module receives the uplink data that is sent by the station that receives the sending acknowledgement message, concurrently send an acknowledgement message to stations that send the received uplink data.

With reference to the eleventh possible implementation manner of the third aspect, in a twelfth possible implementation manner of the third aspect, the concurrently sending an acknowledgement message to stations that send the received uplink data includes:

concurrently sending, on one of subchannels used when the station sends the uplink data, or on a corresponding subchannel on which the station sends the sending request message, the acknowledgement message to the stations that send the received uplink data.

According to a fourth aspect, an embodiment of the present invention provides a station, including:

a receiving module, configured to receive channel opportunity information sent by an access point, where the channel opportunity information includes at least one channel opportunity, and the channel opportunity is a subchannel that can be used by the station to send a sending request message to the access point, and a corresponding subchannel usage time;

a processing module, configured to randomly select a channel opportunity from the channel opportunity information; and

a sending module, configured to send a sending request message to the access point by using the selected channel opportunity, so that the access point allocates, according to the received sending request message, to the station that sends the received sending request message, a channel resource that is used for sending uplink data, and sends, according to the allocated channel resource, a sending acknowledgement message to the station that sends the received sending request message, where

the sending module is further configured to send uplink data by using the allocated channel resource after receiving the sending acknowledgement message.

In a first possible implementation manner of the fourth aspect, the receiving channel opportunity information sent by an access point includes:

receiving a beacon frame sent by the access point, where the beacon frame includes the channel opportunity information.

With reference to the fourth aspect, in a second possible implementation manner of the fourth aspect, the receiving channel opportunity information sent by an access point includes:

receiving an uplink synchronization indication message sent by the access point, where the uplink synchronization indication message includes the channel opportunity information.

With reference to the second possible implementation manner of the fourth aspect, in a third possible implementation manner of the fourth aspect, the receiving module is further configured to:

before receiving the uplink synchronization indication message sent by the access point, receive a beacon frame sent by the access point, where the beacon frame includes a sending time at which the access point sends the uplink synchronization indication message within a current beacon period; and

maintain an awake state at the time at which the uplink synchronization indication message is sent, and receive the uplink synchronization indication message that is sent by the access point at the sending time.

With reference to the second possible implementation manner of the fourth aspect or the third possible implementation manner of the fourth aspect, the uplink synchronization indication message further includes station indication information, where the station indication information includes an identifier of a station that is allowed to send a sending request message, and the processing module is further configured to:

after the receiving module receives the uplink synchronization indication message sent by the access point, determine, according to the station indication information, that the sending request message can be sent to the access point; and

the randomly selecting a channel opportunity from the channel opportunity information, and sending the sending request message to the access point specifically includes:

after the processing module determines that the sending request message can be sent to the access point, randomly selecting a channel opportunity from the channel opportunity information, and sending the sending request message to the access point.

With reference to the method according to any one of the fourth aspect to the fourth possible implementation manner of the fourth aspect, in a fifth possible implementation manner of the fourth aspect, the sending request message includes channel usage time information that is needed to send uplink data by the station that sends the sending request message or volume information of uplink data to be sent by the station that sends the sending request message, so that the access point allocates, according to the channel usage time information that is needed by the station to send the uplink data or the volume information of the uplink data to be sent by the station, where the information is included in the received sending request message, to the station that sends the received sending request message, a subchannel used for sending uplink data, and sends, by using the allocated subchannel, the sending acknowledgement message to the station that sends the received sending request message.

With reference to the method according to any one of the fourth aspect to the fourth possible implementation manner of the fourth aspect, in a sixth possible implementation manner of the fourth aspect, the sending request message includes subchannel indication information that is used to send uplink data by the station that sends the sending request message, so that the access point allocates, according to the subchannel indication information included in the received sending request message, one or more subchannels that are used for sending uplink data, and a corresponding channel usage time to the station that sends the received sending request message, and sends the sending acknowledgement message to the station by using the one or more subchannels that are used for sending uplink data and that are allocated to the station that sends the received sending request message, where the sending acknowledgement message includes the one or more subchannels that are used for sending uplink data and that are allocated to the station that sends the received sending request message, and the corresponding channel usage time.

With reference to the sixth possible implementation manner of the fourth aspect, in a seventh possible implementation manner of the fourth aspect, a transmit address field of the sending request message includes association identifier information of the station that sends the sending request message, and the subchannel indication information.

With reference to the sixth possible implementation manner of the fourth aspect or the seventh possible implementation manner of the fourth aspect, in an eighth possible implementation manner of the fourth aspect, a receive address field of the sending acknowledgement message includes association identifier information of the station that receives the sending acknowledgement message, one or more subchannels that are used for sending uplink data and that are allocated by the access point, and corresponding channel usage time information.

With reference to the method according to any one of the fourth aspect to the eighth possible implementation manner of the fourth aspect, in a ninth possible implementation manner of the fourth aspect, a duration field of the sending request message includes at least channel usage time information that is needed to send uplink data by the station that has data to be sent, so that another station that receives the sending request message sets a network allocation vector time value according to the channel usage time information, and no longer contends for a channel within a corresponding network allocation vector time.

With reference to the method according to any one of the fourth aspect to the ninth possible implementation manner of the fourth aspect, in a tenth possible implementation manner of the fourth aspect, the receiving module is further configured to:

receive an acknowledgement message that is sent by the access point after the access point receives the uplink data.

According to a fifth aspect, an embodiment of the present invention provides an access point, including:

a transmitter, configured to send channel opportunity information, where the channel opportunity information includes at least one channel opportunity, and the channel opportunity is a subchannel that can be used by a station to send a sending request message to the access point, and a corresponding subchannel usage time;

a receiver, configured to receive the sending request message sent by the station; and

a processor, configured to allocate, according to the received sending request message, to the station that sends the received sending request message, a channel resource that is used for sending uplink data, where

the transmitter is further configured to send, according to the allocated channel resource, a sending acknowledgement message to the station that sends the received sending request message, so that stations that receive the sending acknowledgement messages use the channel resources to concurrently send uplink data.

In a first possible implementation manner of the fifth aspect, the sending channel opportunity information includes:

sending a beacon frame, where the beacon frame includes the channel opportunity information.

With reference to the fifth aspect, in a second possible implementation manner of the fifth aspect, the sending channel opportunity information includes:

sending an uplink synchronization indication message, where the uplink synchronization indication message includes the channel opportunity information.

With reference to the second possible implementation manner of the fifth aspect, in a third possible implementation manner of the fifth aspect, before sending the uplink synchronization indication message, the transmitter is further configured to:

send a beacon frame, where the beacon frame includes a sending time at which the access point sends the uplink synchronization indication message within a current beacon period, so that a station that has data to be sent maintains an awake state at the time at which the uplink synchronization indication message is sent, and receives the uplink synchronization indication message.

With reference to the second possible implementation manner of the fifth aspect or the third possible implementation manner of the fifth aspect, in a fourth possible implementation manner of the fifth aspect, the uplink synchronization indication message further includes station indication information, where the station indication information includes an identifier of a station that is allowed to send a sending request message, and the station indication information is used by a station that has data to be sent, to determine, after receiving the uplink synchronization indication message, that a sending request message can be sent to the access point.

With reference to the method according to any one of the fifth aspect to the fourth possible implementation manner of the fifth aspect, in a fifth possible implementation manner of the fifth aspect, the sending request message includes channel usage time information that is needed to send uplink data by the station that sends the sending request message or volume information of uplink data to be sent by the station that sends the sending request message, and the allocating, according to the received sending request message, to the station that sends the received sending request message, a channel resource that is used for sending uplink data includes:

allocating, according to the channel usage time information that is needed by the station to send the uplink data or the volume information of the uplink data to be sent by the station, where the information is included in the received sending request message, to the station that sends the received sending request message, a subchannel used for sending uplink data; and

the sending, according to the allocated channel resource, a sending acknowledgement message to the station that sends the received sending request message includes:

sending, by using the subchannel allocated to the station, the sending acknowledgement message to the station that sends the received sending request message.

With reference to the method according to any one of the fifth aspect to the fourth possible implementation manner of the fifth aspect, in a sixth possible implementation manner of the fifth aspect, the allocating, according to the received sending request message, to the station that sends the received sending request message, a channel resource that is used for sending uplink data includes:

allocating, according to the received sending request message, one or more subchannels that are used for sending uplink data, and a corresponding channel usage time to the station that sends the received sending request message; and

the sending, according to the allocated channel resource, a sending acknowledgement message to the station that sends the received sending request message includes:

sending, by using the one or more subchannels that are used for sending uplink data and that are allocated to the station that sends the received sending request message, the sending acknowledgement message to the station that sends the received sending request message, where the sending acknowledgement message includes the one or more subchannels that are used for sending uplink data and that are allocated to the station that sends the received sending request message, and the corresponding channel usage time.

With reference to the method according to any one of the fifth aspect to the fourth possible implementation manner of the fifth aspect, in a seventh possible implementation manner of the fifth aspect, the sending request message includes subchannel indication information that is used by the station to send uplink data, and the allocating, according to the received sending request message, to the station that sends the received sending request message, a channel resource that is used for sending uplink data includes:

allocating, according to the subchannel indication information included in the received sending request message, one or more subchannels that are used for sending uplink data, and a corresponding channel usage time to the station that sends the received sending request message; and

the sending, according to the allocated channel resource, a sending acknowledgement message to the station that sends the received sending request message includes:

sending, by using the one or more subchannels that are used for sending uplink data and that are allocated to the station that sends the received sending request message, the sending acknowledgement message to the station that sends the received sending request message, where the sending acknowledgement message includes the one or more subchannels that are used for sending uplink data and that are allocated to the station that sends the received sending request message, and the corresponding channel usage time.

With reference to the seventh possible implementation manner of the fifth aspect, in an eighth possible implementation manner of the fifth aspect, a transmit address field of the sending request message includes association identifier information of the station that sends the sending request message, and the subchannel indication information.

With reference to the method according to any one of the sixth possible implementation manner of the fifth aspect to the eighth possible implementation manner of the fifth aspect, in a ninth possible implementation manner of the fifth aspect, a receive address field of the sending acknowledgement message includes association identifier information of the station that receives the sending acknowledgement message, one or more subchannels that are used for sending uplink data and that are allocated by the access point to the station that receives the sending acknowledgement message, and corresponding channel usage time information.

With reference to the method according to any one of the fifth aspect to the ninth possible implementation manner of the fifth aspect, in a tenth possible implementation manner of the fifth aspect, a duration field of the sending request message includes at least channel usage time information that is needed to send uplink data by the station that has data to be sent, so that another station that receives the sending request message sets a network allocation vector time value according to the channel usage time information, and no longer contends for a channel within a corresponding network allocation vector time.

With reference to the method according to any one of the fifth aspect to the tenth possible implementation manner of the fifth aspect, in an eleventh possible implementation manner of the fifth aspect, the transmitter is further configured to:

after the receiver receives the uplink data that is sent by the station that receives the sending acknowledgement message, concurrently send an acknowledgement message to stations that send the received uplink data.

With reference to the eleventh possible implementation manner of the fifth aspect, in a twelfth possible implementation manner of the fifth aspect, the concurrently sending an acknowledgement message to stations that send the received uplink data includes:

concurrently sending, on one of subchannels used when the station sends the uplink data, or on a corresponding subchannel on which the station sends the sending request message, the acknowledgement message to the stations that send the received uplink data.

According to a sixth aspect, an embodiment of the present invention provides a station, including:

a receiver, configured to receive channel opportunity information sent by an access point, where the channel opportunity information includes at least one channel opportunity, and the channel opportunity is a subchannel that can be used by the station to send a sending request message to the access point, and a corresponding subchannel usage time;

a processor, configured to randomly select a channel opportunity from the channel opportunity information; and

a transmitter, configured to send a sending request message to the access point by using the selected channel opportunity, so that the access point allocates, according to the received sending request message, to the station that sends the received sending request message, a channel resource that is used for sending uplink data, and sends, according to the allocated channel resource, a sending acknowledgement message to the station that sends the received sending request message, where the transmitter is further configured to send uplink data by using the allocated channel resource after receiving the sending acknowledgement message.

In a first possible implementation manner of the sixth aspect, the receiving channel opportunity information sent by an access point includes:

receiving a beacon frame sent by the access point, where the beacon frame includes the channel opportunity information.

With reference to the sixth aspect, in a second possible implementation manner of the sixth aspect, the receiving channel opportunity information sent by an access point includes:

receiving an uplink synchronization indication message sent by the access point, where the uplink synchronization indication message includes the channel opportunity information.

With reference to the second possible implementation manner of the sixth aspect, in a third possible implementation manner of the sixth aspect, the receiver is further configured to:

before receiving the uplink synchronization indication message sent by the access point, receive a beacon frame sent by the access point, where the beacon frame includes a sending time at which the access point sends the uplink synchronization indication message within a current beacon period; and

maintain an awake state at the time at which the uplink synchronization indication message is sent, and receive the uplink synchronization indication message that is sent by the access point at the sending time.

With reference to the second possible implementation manner of the sixth aspect or the third possible implementation manner of the sixth aspect, in a fourth possible implementation manner of the sixth aspect, the uplink synchronization indication message further includes station indication information, where the station indication information includes an identifier of a station that is allowed to send a sending request message, and the processor is further configured to:

after the receiver receives the uplink synchronization indication message sent by the access point, determine, according to the station indication information, that the sending request message can be sent to the access point; and

the randomly selecting a channel opportunity from the channel opportunity information, and sending the sending request message to the access point specifically includes:

after the processing module determines that the sending request message can be sent to the access point, randomly selecting a channel opportunity from the channel opportunity information, and sending the sending request message to the access point.

With reference to the method according to any one of the sixth aspect to the fourth possible implementation manner of the sixth aspect, in a fifth possible implementation manner of the sixth aspect, the sending request message includes channel usage time information that is needed to send uplink data by the station that sends the sending request message or volume information of uplink data to be sent by the station that sends the sending request message, so that the access point allocates, according to the channel usage time information that is needed by the station to send the uplink data or the volume information of the uplink data to be sent by the station, where the information is included in the received sending request message, to the station that sends the received sending request message, a subchannel used for sending uplink data, and sends, by using the allocated subchannel, the sending acknowledgement message to the station that sends the received sending request message.

With reference to the method according to any one of the sixth aspect to the fourth possible implementation manner of the sixth aspect, in a sixth possible implementation manner of the sixth aspect, the sending request message includes subchannel indication information that is used to send uplink data by the station that sends the sending request message, so that the access point allocates, according to the subchannel indication information included in the received sending request message, one or more subchannels that are used for sending uplink data, and a corresponding channel usage time to the station that sends the received sending request message, and sends the sending acknowledgement message to the station by using the one or more subchannels that are used for sending uplink data and that are allocated to the station that sends the received sending request message, where the sending acknowledgement message includes the one or more subchannels that are used for sending uplink data and that are allocated to the station that sends the received sending request message, and the corresponding channel usage time.

With reference to the sixth possible implementation manner of the sixth aspect, in a seventh possible implementation manner of the sixth aspect, a transmit address field of the sending request message includes association identifier information of the station that sends the sending request message, and the subchannel indication information.

With reference to the sixth possible implementation manner of the sixth aspect or the seventh possible implementation manner of the sixth aspect, in an eighth possible implementation manner of the sixth aspect, a receive address field of the sending acknowledgement message includes association identifier information of the station that receives the sending acknowledgement message, one or more subchannels that are used for sending uplink data and that are allocated by the access point, and corresponding channel usage time information.

With reference to the method according to any one of the sixth aspect to the eighth possible implementation manner of the sixth aspect, in a ninth possible implementation manner of the sixth aspect, a duration field of the sending request message includes at least channel usage time information that is needed to send uplink data by the station that has data to be sent, so that another station that receives the sending request message sets a network allocation vector time value according to the channel usage time information, and no longer contends for a channel within a corresponding network allocation vector time.

With reference to the method according to any one of the sixth aspect to the ninth possible implementation manner of the sixth aspect, in a tenth possible implementation manner of the sixth aspect, the receiver is further configured to:

receive an acknowledgement message that is sent by the access point after the access point receives the uplink data.

According to the data transmission method and apparatus provided in the embodiments of the present invention, an access point sends channel opportunity information, so that stations that have data to be sent randomly select, after receiving the channel opportunity information, a channel opportunity from the channel opportunity information, and concurrently send a sending request message to the access point; then the access point allocates, according to the received sending request message, to a station that sends the received sending request message, a channel resource that is used for sending uplink data; and finally, the access point sends, according to the allocated channel resource, a sending acknowledgement message to the station that sends the received sending request message, so that stations that receive the sending acknowledgement message use channel resources to concurrently send uplink data. Therefore, a synchronization requirement that multiple stations use different subcarriers to concurrently send data can be well met.

### BRIEF DESCRIPTION OF DRAWINGS

To describe the technical solutions in the embodiments of the present invention or in the prior art more clearly, the following briefly introduces the accompanying drawings required for describing the embodiments or the prior art. Apparently, the accompanying drawings in the following description show some embodiments of the present invention, and persons of ordinary skill in the art may still derive other drawings from these accompanying drawings without creative efforts.

FIG. 1 is a flowchart of Embodiment 1 of a data transmission method according to the present invention;

FIG. 2 is a flowchart of Embodiment 2 of a data transmission method according to the present invention;

FIG. 3 is a signaling interaction diagram of Embodiment 3 of a data transmission method according to the present invention;

FIG. 4 is a schematic format diagram of an RTS frame in Embodiment 3 of a data transmission method according to the present invention;

FIG. 5 is a schematic format diagram of a CTS frame in Embodiment 3 of a data transmission method according to the present invention;

FIG. 6 is a signaling interaction diagram of Embodiment 4 of a data transmission method according to the present invention;

FIG. 7 is a schematic format diagram of an RTS frame in Embodiment 4 of a data transmission method according to the present invention;

FIG. 8 is a schematic format diagram of a CTS frame in Embodiment 4 of a data transmission method according to the present invention;

FIG. 9 is a schematic structural diagram of Embodiment 1 of an access point according to the present invention;

FIG. 10 is a schematic structural diagram of Embodiment 1 of a station according to the present invention;

FIG. 11 is a schematic structural diagram of Embodiment 2 of an access point according to the present invention; and

FIG. 12 is a schematic structural diagram of Embodiment 2 of a station according to the present invention.

### DESCRIPTION OF EMBODIMENTS

To make the objectives, technical solutions, and advantages of the embodiments of the present invention clearer, the following clearly and completely describes the technical solutions in the embodiments of the present invention with reference to the accompanying drawings in the embodiments of the present invention. Apparently, the described embodiments are some but not all of the embodiments of the present invention. All other embodiments obtained by persons of ordinary skill in the art based on the embodiments of the present invention without creative efforts shall fall within the protection scope of the present invention.

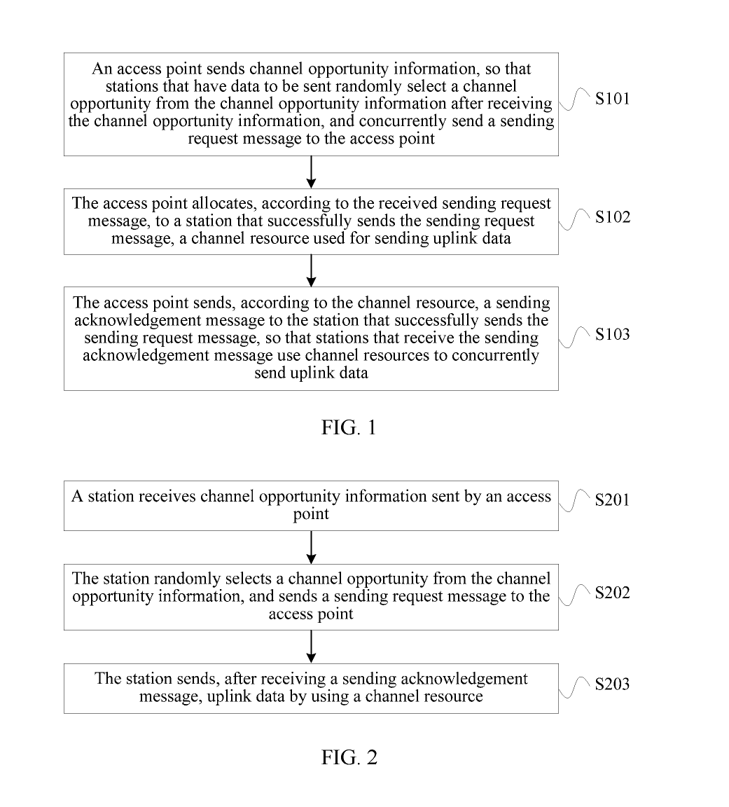

FIG. 1 is a flowchart of Embodiment 1 of a data transmission method according to the present invention. This embodiment is described by using an example in which an access point is used as an execution body. As shown in FIG. 1, the method of this embodiment may include:

S101. An access point sends channel opportunity information, where the channel opportunity information includes at least one channel opportunity, and the channel opportunity is a subchannel that can be used by a station to send a sending request message to the access point, and a corresponding subchannel usage time.

There are two implementable manners for sending channel opportunity information by an access point.

Manner 1. The access point sends a beacon frame, where the beacon frame includes the channel opportunity information. The access point may send the beacon frame to all stations in broadcast mode or to some stations in multicast mode.

Manner 2. The access point sends an uplink synchronization indication message, where the uplink synchronization indication message includes the channel opportunity information. The access point may send the uplink synchronization indication message to all stations in broadcast mode or to some stations in multicast mode. The uplink synchronization indication message may be a CTS frame.

In another implementable manner, before the sending, by the access point, an uplink synchronization indication message, the method further includes:

sending, by the access point, a beacon frame, where the beacon frame includes information about a sending time at which the access point sends the uplink synchronization indication message within a current beacon period, so that a station that has data to be sent maintains an awake state at the time at which the uplink synchronization indication message is sent, and receives the uplink synchronization indication message, which is more power-saving for the station.

Further, the uplink synchronization indication message may further include station indication information, where the station indication information includes an identifier of a station that is allowed to send a sending request message, and the station indication information is used by a station that has data to be sent, to determine, after receiving the uplink synchronization indication message, that a sending request message can be sent to the access point. Specifically, after receiving the uplink synchronization indication message, the station that has data to be sent determines, according to the station indication information included in the uplink synchronization indication message, whether the station that has data to be sent can send a sending request message to the access point. The station indication information may include multiple station identifiers, or may include one station identifier and a quantity N of N stations that are obtained by counting from a station that corresponds to the station identifier, or may include two station identifiers, specifying that stations between the two station identifiers can send a sending request message. In this way, stations that have data to be sent can be allocated to each beacon frame period, thereby reducing a conflict caused by data sending. Herein, it should be noted that, if no station sends a sending request message after the access point sends an uplink synchronization indication message, the access point needs to change station indication information in the uplink synchronization indication message, and resend an uplink synchronization indication message, until it is determined that a station that has data to be sent has an opportunity to send a sending request message.

S102. The access point allocates, according to the received sending request message, to the station that sends the received sending request message, a channel resource that is used for sending uplink data.

S103. The access point sends, according to the allocated channel resource, a sending acknowledgement message to the station that sends the received sending request message, so that stations that receive the sending acknowledgement message use channel resources to concurrently send uplink data.

Specifically, in an implementable manner, the sending request message includes channel usage time information that is needed to send uplink data by the station that sends the sending request message or volume information of uplink data to be sent by the station, and in this case, the allocating, by the access point according to the received sending request message, to the station that sends the received sending request message, a channel resource that is used for sending uplink data is specifically:

allocating, by the access point according to the channel usage time information that is needed by the station to send the uplink data or the volume information of the uplink data to be sent by the station, where the information is included in the received sending request message, to the station that sends the received sending request message, a subchannel used for sending uplink data.

The sending, by the access point according to the allocated channel resource, a sending acknowledgement message to the station that sends the received sending request message is specifically:

sending, by the access point by using the subchannel allocated to the station, the sending acknowledgement message to the station that sends the received sending request message.

In another implementable manner, the allocating, by the access point according to the received sending request message, to the station that sends the received sending request message, a channel resource that is used for sending uplink data is specifically:

allocating, by the access point according to the received sending request message, one or more subchannels that are used for sending uplink data, and a corresponding channel usage time to the station that sends the received sending request message.

Further, the sending request message includes subchannel indication information that is used by the station to send uplink data, where the subchannel indication information includes one or more subchannels that are used for sending the sending request message and that are indicated by the station; and the allocating, by the access point according to the received sending request message, to the station that sends the received sending request message, a channel resource that is used for sending uplink data is specifically:

allocating, by the access point according to the subchannel indication information included in the received sending request message, one or more subchannels that are used for sending uplink data, and a corresponding channel usage time to the station that sends the received sending request message. According to a subchannel that has an idle channel and that is indicated by the station, the access point can better allocate, to the station, a subchannel that is used for sending uplink data.

The sending, by the access point according to the allocated channel resource, a sending acknowledgement message to the station that sends the received sending request message is specifically:

sending, by the access point by using the one or more subchannels that are used for sending uplink data and that are allocated to the station, the sending acknowledgement message to the station that sends the received sending request message, where the sending acknowledgement message includes the one or more subchannels that are used for sending uplink data and that are allocated to the station, and the corresponding channel usage time.

A transmit address field of the sending request message includes association identifier information of the station that sends the sending request message, and the subchannel indication information. The subchannel indication information includes the one or more subchannels that are used for sending the sending request message and that are indicated by the station.

A receive address field of the sending acknowledgement message includes association identifier information of the station that receives the sending acknowledgement message, one or more subchannels that are used for sending uplink data and that are allocated by the access point to the station that receives the sending acknowledgement message, and corresponding channel usage time information.

In the foregoing two implementation manners, a duration field of the sending request message includes at least a channel usage time that is needed to send uplink data by the station that has data to be sent, so that another station that receives the sending request message sets a network allocation vector time value according to the channel usage time, and no longer contends for a channel within a corresponding network allocation vector time. Therefore, a conflict caused by data sending can be avoided.

Further, the method further includes:

concurrently sending, by the access point after receiving the uplink data that is sent by the station, an acknowledgement message to stations that send the received uplink data, which may be: concurrently sending, by the access point, on one of subchannels used when the station sends the uplink data, or on a corresponding subchannel on which the station sends the sending request message, the acknowledgement message to the stations that successfully send the uplink data.

According to the data transmission method provided in this embodiment of the present invention, an access point sends channel opportunity information, so that stations that have data to be sent randomly select, after receiving the channel opportunity information, a channel opportunity from the channel opportunity information, and concurrently send a sending request message to the access point; then the access point allocates, according to the received sending request message, to a station that sends the received sending request message, a channel resource that is used for sending uplink data; and finally, the access point sends, according to the allocated channel resource, a sending acknowledgement message to the station that sends the received sending request message, so that stations that receive the sending acknowledgement message use channel resources to concurrently send uplink data. Therefore, a synchronization requirement that multiple stations use different subcarriers to concurrently send data can be well met.

FIG. 2 is a flowchart of Embodiment 2 of a data transmission method according to the present invention. This embodiment is described by using an example in which a station is used as an execution body. As shown in FIG. 2, the method of this embodiment may include:

S201. A station receives channel opportunity information sent by an access point, where the channel opportunity information includes at least one channel opportunity, and the channel opportunity is a subchannel that can be used by the station to send a sending request message to the access point, and a corresponding subchannel usage time.

Stations in this embodiment all refer to stations that have data to be sent. There are two implementable manners for receiving, by a station, channel opportunity information sent by an access point.

Manner 1. The station receives a beacon frame sent by the access point, where the beacon frame includes the channel opportunity information.

Manner 2. The station receives an uplink synchronization indication message sent by the access point, where the uplink synchronization indication message includes the channel opportunity information. The uplink synchronization indication message may be a CTS frame.

Before the receiving, by the station, an uplink synchronization indication message sent by the access point, the method further includes:

receiving, by the station, a beacon frame sent by the access point, where the beacon frame includes a sending time at which the access point sends the uplink synchronization indication message within a current beacon period; and

maintaining, by the station, an awake state at the time at which the uplink synchronization indication message is sent, and receiving the uplink synchronization indication message that is sent by the access point at the sending time, which is more power-saving for the station.

Further, the uplink synchronization indication message further includes station indication information, where the station indication information includes an identifier of a station that is allowed to send a sending request message. Specifically, the station indication information may include multiple station identifiers, or may include one station identifier and a quantity N of N stations that are obtained by counting from a station that corresponds to the station identifier, or may include two station identifiers, specifying that stations between the two station identifiers can send a sending request message. In this way, stations that have data to be sent can be allocated to each beacon frame period, thereby reducing a conflict caused by data sending. Herein, it should be noted that, if no station sends a sending request message after the access point sends an uplink synchronization indication message, the access point needs to change station indication information in the uplink synchronization indication message, and resend an uplink synchronization indication message, until it is determined that a station that has data to be sent has an opportunity to send a sending request message. After the receiving, by the station, the uplink synchronization indication message that is sent by the access point, the method includes: determining, according to the station indication information, that the sending request message can be sent to the access point. Correspondingly, the randomly selecting, by the station, a channel opportunity from the channel opportunity information, and sending the sending request message to the access point specifically includes:

after determining, according to the station indication information, that the sending request message can be sent to the access point, randomly selecting, by the station, a channel opportunity from the channel opportunity information, and sending the sending request message to the access point.

S202. The station randomly selects a channel opportunity from the channel opportunity information, and sends the sending request message to the access point, so that the access point allocates, according to the received sending request message, to the station that sends the received sending request message, a channel resource that is used for sending uplink data, and sends, according to the allocated channel resource, a sending acknowledgement message to the station that sends the received sending request message.

S203. The station sends, after receiving the sending acknowledgement message, uplink data by using the allocated channel resource.

Specifically, in an implementable manner, the sending request message includes channel usage time information that is needed to send uplink data by the station that sends the sending request message or volume information of uplink data to be sent by the station that sends the sending request message, so that the access point allocates, according to the channel usage time information that is needed by the station to send the uplink data or the volume information of the uplink data to be sent by the station, where the information is included in the received sending request message, to the station that sends the received sending request message, a subchannel used for sending uplink data, and sends, by using the allocated subchannel, the sending acknowledgement message to the station that sends the received sending request message.

In another implementable manner, the sending request message includes subchannel indication information that is used to send uplink data by the station that sends the sending request message, so that the access point allocates, according to the subchannel indication information included in the received sending request message, one or more subchannels that are used for sending uplink data, and a corresponding channel usage time to the station that sends the received sending request message, and sends the sending acknowledgement message to the station by using the one or more subchannels that are used for sending uplink data and that are allocated to the station that sends the received sending request message, where the sending acknowledgement message includes the one or more subchannels that are used for sending uplink data and that are allocated to the station, and the corresponding channel usage time.

A transmit address field of the sending request message includes association identifier information of the station that sends the sending request message, and the subchannel indication information.

A receive address field of the sending acknowledgement message includes association identifier information of the station that receives the sending acknowledgement message, one or more subchannels that are used for sending uplink data and that are allocated by the access point, and corresponding channel usage time information.

In the foregoing two implementation manners, a duration field of the sending request message includes at least a channel usage time that is needed to send uplink data by the station that has data to be sent, so that another station that receives the sending request message sets a network allocation vector time value according to the channel usage time, and no longer contends for a channel within a corresponding network allocation vector time.

Further, the method further includes: receiving, by the station, an acknowledgement message that is sent by the access point after the access point receives the uplink data.

According to the data transmission method provided in this embodiment, a station that has data to be sent receives channel opportunity information sent by an access point, randomly selects a channel opportunity from the channel opportunity information, and sends a sending request message to the access point, so that the access point allocates, to the station according to the received sending request message, a channel resource that is used for sending uplink data, and sends a sending acknowledgement message to the station according to the allocated channel resource, so that the station uses, after receiving the sending acknowledgement message, the allocated channel resource to send uplink data. Therefore, a synchronization requirement that multiple stations use different subcarriers to concurrently send data can be well met.

The technical solutions of the method embodiments shown above are described in detail by using two specific embodiments below.

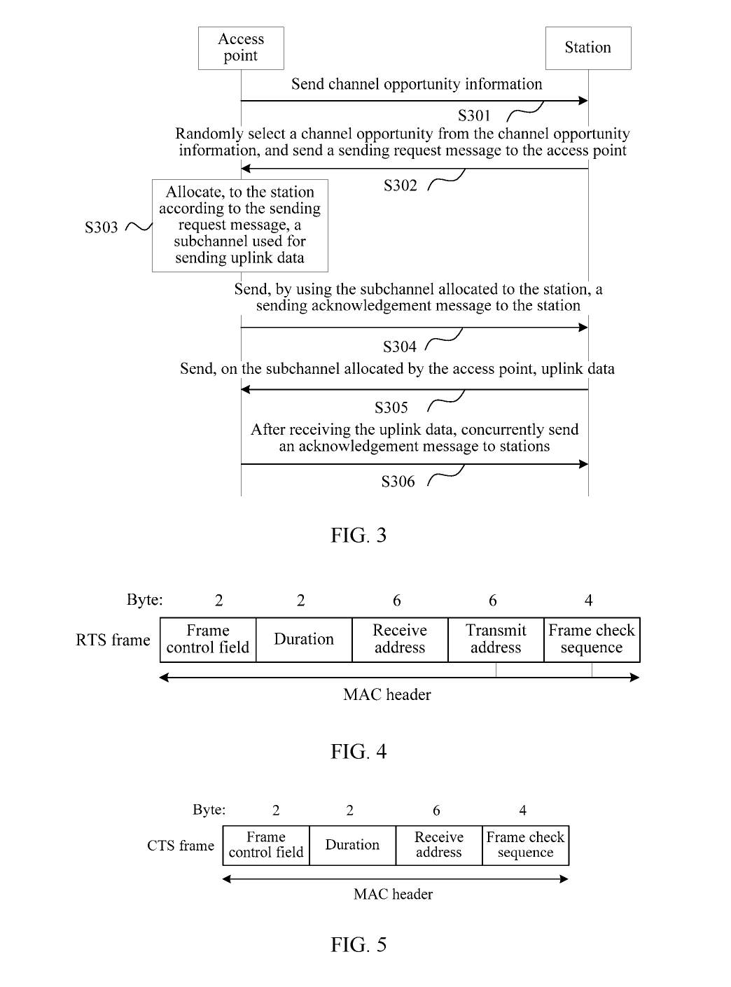

FIG. 3 is a signaling interaction diagram of Embodiment 3 of a data transmission method according to the present invention. As shown in FIG. 3, the method of this embodiment may include:

S301. An access point sends channel opportunity information, where the channel opportunity information includes at least one channel opportunity, and the channel opportunity is a subchannel that can be used by a station to send a sending request message to the access point, and a corresponding subchannel usage time.

There are two implementable manners for sending channel opportunity information by an access point.

Manner 1. The access point sends a beacon frame, where the beacon frame includes the channel opportunity information. The access point may send the beacon frame to all stations in broadcast mode or to some stations in multicast mode.

Manner 2. The access point sends an uplink synchronization indication message, where the uplink synchronization indication message includes the channel opportunity information. The access point may send the uplink synchronization indication message to all stations in broadcast mode or to some stations in multicast mode. The uplink synchronization indication message may be a CTS frame.

In another implementable manner, before the sending, by the access point, an uplink synchronization indication message, the method further includes:

sending, by the access point, a beacon frame, where the beacon frame includes a sending time at which the access point sends the uplink synchronization indication message within a current beacon period, so that a station that has data to be sent maintains an awake state at the time at which the uplink synchronization indication message is sent, and receives the uplink synchronization indication message, which is more power-saving for the station.

Further, the uplink synchronization indication message may further include station indication information, where the station indication information includes an identifier of a station that is allowed to send a sending request message, and the station indication information is used by a station that has data to be sent, to determine, after receiving the uplink synchronization indication message, that a sending request message can be sent to the access point. The station indication information may include multiple station identifiers, or may include one station identifier and a quantity N of N stations that are obtained by counting from a station that corresponds to the station identifier, or may include two station identifiers, specifying that stations between the two station identifiers can send a sending request message. In this way, stations that have data to be sent can be allocated to each beacon frame period, thereby reducing a conflict caused by data sending. Herein, it should be noted that, if no station sends a sending request message after the access point sends an uplink synchronization indication message, the access point needs to change station indication information in the uplink synchronization indication message, and resend an uplink synchronization indication message, until it is determined that a station that has data to be sent has an opportunity to send a sending request message.

S302. After the station receives the channel opportunity information sent by the access point, the station randomly selects a channel opportunity from the channel opportunity information, and sends the sending request message to the access point.

The sending request message includes channel usage time information that is needed to send uplink data by the station that has data to be sent or volume information of uplink data to be sent by the station. Specifically, a duration field of the sending request message includes at least a channel usage time that is needed by the station to send uplink data, so that another station that receives the sending request message sets a network allocation vector time value according to the channel usage time, and no longer contends for a channel within a corresponding network allocation vector time. Therefore, a conflict caused by data sending can be avoided. For example, the sending request message is an RTS frame. FIG. 4 is a schematic format diagram of an RTS frame in Embodiment 3 of a data transmission method according to the present invention. As shown in FIG. 4, a Media Access Control layer (MAC) header of the RTS frame includes a frame control field (2 bytes), a duration field (2 bytes), a receive address field (6 bytes), a transmit address field (6 bytes), and a frame check sequence (4 bytes).

S303. For a station that successfully sends a sending request message, the access point allocates, according to channel usage time information that is needed by the station to send uplink data or volume information of uplink data to be sent by the station, where the information is included in the received sending request message, to the station that sends the received sending request message, a subchannel used for sending uplink data.

S304. The access point sends, by using the subchannel allocated to the station, a sending acknowledgement message to the station that sends the received sending request message.

After sending the sending request message, the station waits on each subchannel to receive the sending acknowledgement message, and identifies and determines a subchannel on which the sending acknowledgement message is sent to the station. For a case in which a same channel opportunity is selected to send sending request messages to the access point, because the access point cannot identify conflicting sending request messages, the sending request messages are considered as invalid messages, and for an invalid sending request message, the access point does not return a request acknowledgement message.

Herein, it should be noted that, in the sending acknowledgement message returned by the access point, the access point not only may determine a value of a “duration” field in the sending acknowledgement message by means of a method defined in an existing standard, but also may perform recalculation to obtain a value of a “duration” field in the sending acknowledgement message according to a value of a “duration” field in the sending request message and a quantity of subchannels that are actually allocated to the station. For example, the sending acknowledgement message is a CTS frame. FIG. 5 is a schematic format diagram of a CTS frame in Embodiment 3 of a data transmission method according to the present invention. As shown in FIG. 5, a Media Access Control layer (MAC) header of the CTS frame includes a frame control field (2 bytes), a duration field (2 bytes), a receive address field (6 bytes), and a frame check sequence (4 bytes).

S305. After receiving the sending acknowledgement message, the station sends, on the subchannel allocated by the access point, uplink data.

Herein, it means that all stations that receive the sending acknowledgement message separately and concurrently send, on subchannels allocated by the access point, uplink data. It should be noted that, when the access point allocates multiple subchannels to the station as channel resources for sending uplink data, the station needs to copy, to each subchannel, content of a physical frame header that includes physical frame length information and concurrently send the content, so that another station sets, when receiving an uplink data frame, a network allocation vector (NAV) time value of the another station by using frame length information of a corresponding physical frame header, so that within such specified duration, the another station no longer contends for a channel, and a conflict can be avoided.

S306. After receiving the uplink data sent by the station, the access point separately and concurrently sends an acknowledgement message to stations that successfully send uplink data.

The access point may concurrently send, by using one of subchannels used when the station sends the uplink data, or by using a corresponding subchannel on which the station sends the sending request message, the acknowledgement message to the stations that successfully send the uplink data.

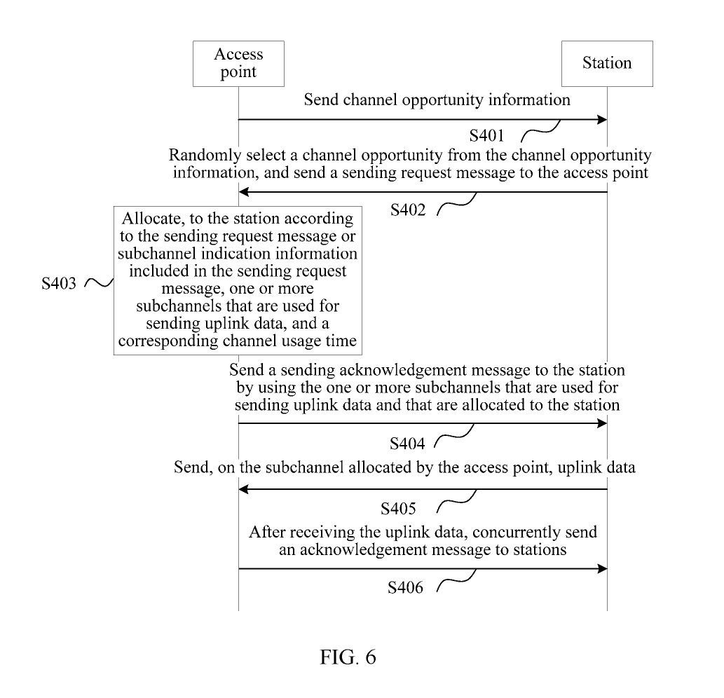

FIG. 6 is a signaling interaction diagram of Embodiment 4 of a data transmission method according to the present invention. As shown in FIG. 6, the method of this embodiment may include:

S401. An access point sends channel opportunity information, where the channel opportunity information includes at least one channel opportunity, and the channel opportunity is a subchannel that can be used by a station to send a sending request message to the access point, and a corresponding subchannel usage time.

There are two implementable manners for sending channel opportunity information by an access point.

Manner 1. The access point sends a beacon frame, where the beacon frame includes the channel opportunity information. The access point may send the beacon frame to all stations in broadcast mode or to some stations in multicast mode.

Manner 2. The access point sends an uplink synchronization indication message, where the uplink synchronization indication message includes the channel opportunity information. The access point may send the uplink synchronization indication message to all stations in broadcast mode or to some stations in multicast mode. The uplink synchronization indication message may be a CTS frame.

In another implementable manner, before the sending, by the access point, an uplink synchronization indication message, the method further includes:

sending, by the access point, a beacon frame, where the beacon frame includes a sending time at which the access point sends the uplink synchronization indication message within a current beacon period, so that a station that has data to be sent maintains an awake state at the time at which the uplink synchronization indication message is sent, and receives the uplink synchronization indication message, which is more power-saving for the station.

Further, the uplink synchronization indication message may further include station indication information, where the station indication information includes an identifier of a station that is allowed to send a sending request message, and the station indication information is used by a station that has data to be sent, to determine, after receiving the uplink synchronization indication message, that a sending request message can be sent to the access point. The station indication information may include multiple station identifiers, or may include one station identifier and a quantity N of N stations that are obtained by counting from a station that corresponds to the station identifier, or may include two station identifiers, specifying that stations between the two station identifiers can send a sending request message. In this way, stations that have data to be sent can be allocated to each beacon frame period, thereby reducing a conflict caused by data sending. Herein, it should be noted that, if no station sends a sending request message after the access point sends an uplink synchronization indication message, the access point needs to change station indication information in the uplink synchronization indication message, and resend an uplink synchronization indication message, until it is determined that a station that has data to be sent has an opportunity to send a sending request message.

S402. After the station receives the channel opportunity information sent by the access point, the station randomly selects a channel opportunity from the channel opportunity information, and sends the sending request message to the access point.

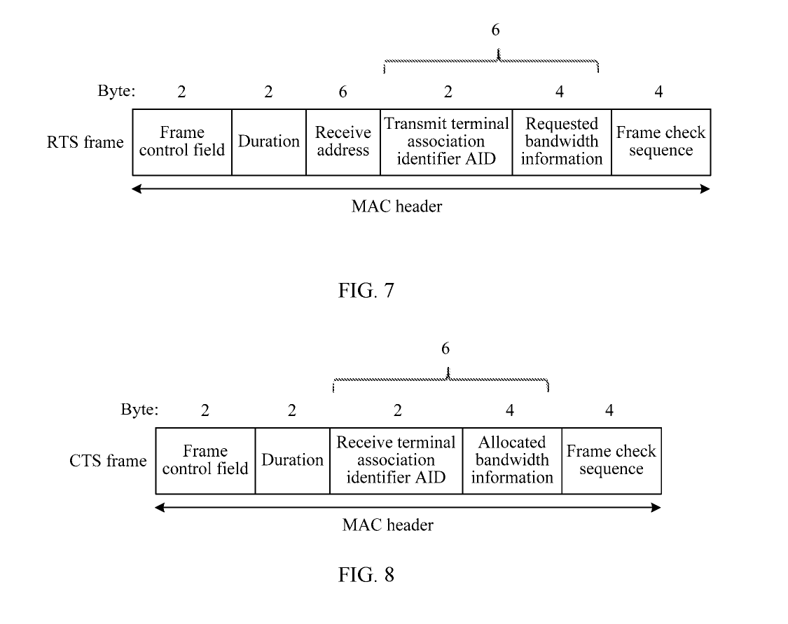

Further, the sending request message may further include subchannel indication information that is used to send uplink data by the station that has data to be sent, where the subchannel indication information includes one or more subchannels that are used for sending the sending request message and that are indicated by the station. According to a subchannel that has an idle channel and that is indicated by the station, the access point can better allocate, to the station, a subchannel that is used for sending uplink data. The subchannel indication information may be specifically: a transmit address field of the sending request message includes association identifier information of the station that sends the sending request message, and the subchannel indication information. The sending request message is an RTS frame, and a specific indication manner is shown in FIG. 7. FIG. 7 is a schematic format diagram of an RTS frame in Embodiment 4 of a data transmission method according to the present invention. As shown in FIG. 7, a Media Access Control layer (MAC) header of the RTS frame includes a frame control field (2 bytes), a duration field (2 bytes), a receive address field (6 bytes), a transmit terminal association identifier AID field (2 bytes), a requested bandwidth information field (4 bytes), and a frame check sequence (4 bytes). The transmit terminal association identifier AID field is used to carry the association identifier information of the station that sends the sending request message, and the requested bandwidth information field is used to carry the subchannel indication information, where the subchannel indication information is, for example, number information of a subchannel. It should be noted that, because multiple stations randomly select a sending opportunity for sending a sending request message, multiple stations may select a same sending opportunity to send an RTS message to the access point; in this case, RTS messages sent by the multiple stations may be in conflict. In addition, a duration value of a “duration” field in the RTS frame may still be determined by the station according to channel usage duration that is needed by the station to use a subchannel to send data, so that another station that receives the RTS frame uses the duration value to set an NAV time value of the another station, so that within such specified duration, the another station no longer contends for a channel.

S403. The access point allocates, according to the received sending request message or subchannel indication information included in the sending request message, one or more subchannels that are used for sending uplink data, and a corresponding channel usage time to the station that sends the received sending request message.

S404. The access point sends, by using the one or more subchannels that are used for sending uplink data and that are allocated to the station, a sending acknowledgement message to the station that sends the received sending request message, where the sending acknowledgement message includes the one or more subchannels that are used for sending uplink data and that are allocated to the station, and the corresponding channel usage time.

A receive address field of the sending acknowledgement message includes association identifier information of the station that receives the sending acknowledgement message, one or more subchannels that are used for sending uplink data and that are allocated by the access point to the station, and corresponding channel usage time information.

A specific indication manner is shown in FIG. 8. FIG. 8 is a schematic format diagram of a CTS frame in Embodiment 4 of a data transmission method according to the present invention. As shown in FIG. 8, a Media Access Control layer (MAC) header of the CTS frame includes a frame control field (2 bytes), a duration field (2 bytes), a receive terminal association identifier AID field (2 bytes), an allocated bandwidth information field (4 bytes), and a frame check sequence (4 bytes). The receive terminal association identifier AID field is used to carry the association identifier information of the station that receives the sending acknowledgement message, and the requested bandwidth information field is used to carry the one or more subchannels that are used for sending uplink data and that are allocated by the access point to the station, and the corresponding channel usage time information. For example, specific channel resource information in the allocated bandwidth information field may be indicated by means of at least the following method: values of 12 binary digits in four bytes are used to indicate number information that corresponds to the subchannel that is allocated by the access point to the station, then values of 12 binary digits thereof are used to indicate a starting time at which the station can use the allocated subchannel, and finally, values of 8 remaining binary digits are used to indicate duration in which the station can use the allocated subchannel. For a case in which a same sending opportunity is selected to send RTS messages to the access point, because the access point cannot identify conflicting RTS messages, the RTS messages are considered as invalid messages, and for an invalid RTS message, the access point does not send a CTS message. In this step, it should be noted that, in the CTS message sent by the access point, the access point not only may determine a value of a “duration” field in the CTS message according to a value of a “duration” field in the RTS message, but also may perform recalculation to obtain a channel usage time according to a value of a “duration” field in the RTS message and a quantity of subchannels that are actually allocated to the station.

S405. After receiving the sending acknowledgement message, the station sends, on the subchannel allocated by the access point, uplink data.

Specifically, it means that all stations that receive the sending acknowledgement message separately and concurrently send, on subchannels allocated by the access point, uplink data. The station determines, according to allocated bandwidth information included in the received CTS message that includes association identifier information of the station, a channel resource allocated by the access point to the station, and then multiple stations separately and concurrently send, on channel resources allocated by the access point to the multiple stations, uplink data. It should be noted that, when the access point allocates multiple subchannels to the station as channel resources for sending uplink data, the station needs to copy, to each subchannel, content of a physical frame header that includes physical frame length information and concurrently send the content, so that another station sets, when receiving an uplink data frame, an NAV time value of the another station by using frame length information of a corresponding physical frame header, so that within such specified duration, the another STA no longer contends for a channel.

S406. After receiving the uplink data sent by the station, the access point separately and concurrently sends an acknowledgement message to stations that successfully send uplink data.

The access point may concurrently send, by using one of subchannels used when the station sends the uplink data, or by using a corresponding subchannel on which the station sends the sending request message, the acknowledgement message to the stations that successfully send the uplink data.

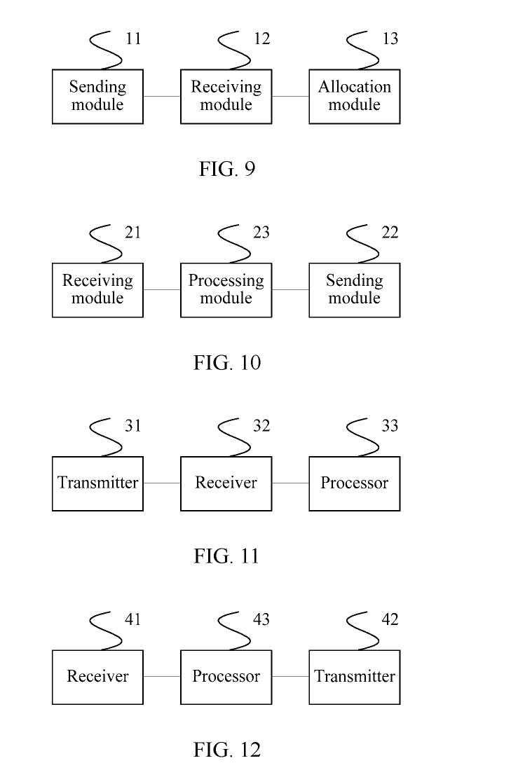

FIG. 9 is a schematic structural diagram of Embodiment 1 of an access point according to the present invention. As shown in FIG. 9, the access point of this embodiment may include: a sending module 11, a receiving module 12, and an allocation module 13, where the sending module 11 is configured to send channel opportunity information, where the channel opportunity information includes at least one channel opportunity, and the channel opportunity is a subchannel that can be used by a station to send a sending request message to the access point, and a corresponding subchannel usage time; the receiving module 12 is configured to receive the sending request message sent by the station; and the allocation module 13 is configured to allocate, according to the sending request message, to the station that sends the received sending request message, a channel resource that is used for sending uplink data, where the sending module 11 is further configured to send, according to the allocated channel resource, a sending acknowledgement message to the station that sends the received sending request message, so that stations that receive the sending acknowledgement message use channel resources to concurrently send uplink data.

Further, the sending, by the sending module 11, channel opportunity information includes:

sending, by the sending module 11, a beacon frame, where the beacon frame includes the channel opportunity information; or sending an uplink synchronization indication message, where the uplink synchronization indication message includes the channel opportunity information, where the uplink synchronization indication message may be a CTS frame.

Further, before sending the uplink synchronization indication message, the sending module 11 is further configured to: send a beacon frame, where the beacon frame includes information about a sending time at which the access point sends the uplink synchronization indication message within a current beacon period, so that a station that has data to be sent maintains an awake state at the time at which the uplink synchronization indication message is sent, and receives the uplink synchronization indication message.

In an implementable manner, the uplink synchronization indication message may further include station indication information, where the station indication information includes an identifier of a station that is allowed to send a sending request message, and the station indication information is used by a station that has data to be sent, to determine, after receiving the uplink synchronization indication message, that a sending request message can be sent to the access point.

In the foregoing embodiment, in an implementable manner, the sending request message includes channel usage time information that is needed to send uplink data by the station that sends the sending request message or volume information of uplink data to be sent by the station that sends the sending request message, and the allocating, by the allocation module 13 according to the received sending request message, to the station that sends the received sending request message, a channel resource that is used for sending uplink data includes:

allocating, by the allocation module 13 according to the channel usage time information that is needed by the station to send the uplink data or the volume information of the uplink data to be sent by the station, where the information is included in the received sending request message, to the station that sends the received sending request message, a subchannel used for sending uplink data; and the sending, by the sending module 11 according to the allocated channel resource, a sending acknowledgement message to the station that sends the received sending request message includes:

sending, by the sending module 11 by using the subchannel allocated to the station, the sending acknowledgement message to the station that sends the received sending request message.

In another implementable manner, the sending request message includes subchannel indication information that is used by the station to send uplink data, and the allocating, by the allocation module 13 according to the received sending request message, to the station that sends the received sending request message, a channel resource that is used for sending uplink data includes:

allocating, by the allocation module 13 according to the received sending request message, one or more subchannels that are used for sending uplink data, and a corresponding channel usage time to the station that sends the received sending request message; and

the sending, by the sending module 11 according to the allocated channel resource, a sending acknowledgement message to the station that sends the received sending request message includes:

sending, by the sending module 11 by using the one or more subchannels that are used for sending uplink data and that are allocated to the station, the sending acknowledgement message to the station that sends the received sending request message, where the sending acknowledgement message includes the one or more subchannels that are used for sending uplink data and that are allocated to the station, and the corresponding channel usage time.

In another implementable manner, the allocating, by the allocation module 13 according to the received sending request message, to the station that sends the received sending request message, a channel resource that is used for sending uplink data includes:

allocating, by the allocation module 13 according to the subchannel indication information included in the received sending request message, to the station that sends the received sending request message, one or more subchannels that are used for sending uplink data, and a corresponding channel usage time; and

the sending, by the sending module 11 according to the allocated channel resource, a sending acknowledgement message to the station that sends the received sending request message includes:

sending, by the sending module 11 by using the one or more subchannels that are used for sending uplink data and that are allocated to the station, the sending acknowledgement message to the station that sends the received sending request message, where the sending acknowledgement message includes the one or more subchannels that are used for sending uplink data and that are allocated to the station, and the corresponding channel usage time.

Further, a transmit address field of the sending request message includes association identifier information of the station that sends the sending request message, and the subchannel indication information.

A receive address field of the sending acknowledgement message includes association identifier information of the station that receives the sending acknowledgement message, one or more subchannels that are used for sending uplink data and that are allocated by the access point to the station that receives the sending acknowledgement message, and corresponding channel usage time information.

In the foregoing embodiment, further, a duration field of the sending request message includes at least a channel usage time that is needed to send uplink data by the station that has data to be sent, so that another station that receives the sending request message sets a network allocation vector time value according to the channel usage time, and no longer contends for a channel within a corresponding network allocation vector time.

In the foregoing embodiment, further, the sending module 11 is further configured to:

after the receiving module 12 receives the uplink data that is sent by the station that receives the sending acknowledgement message, concurrently send an acknowledgement message to stations that send the received uplink data.

The concurrently sending, by the sending module 11, an acknowledgement message to stations that send the received uplink data includes:

concurrently sending, by the sending module 11, on one of subchannels used when the station sends the uplink data, or on a corresponding subchannel on which the station sends the sending request message, the acknowledgement message to the stations that send the received uplink data.

The access point of this embodiment may be used for performing the technical solution of the method embodiment shown in FIG. 1, and an implementation principle thereof is similar, which is not described herein again.

According to the access point provided in this embodiment, a sending module sends channel opportunity information, so that stations that have data to be sent randomly select, after receiving the channel opportunity information, a channel opportunity from the channel opportunity information, and concurrently send a sending request message to the access point; then an allocation module allocates, according to the sending request message received by a receiving module, to a station that sends the received sending request message, a channel resource that is used for sending uplink data; and finally, the sending module sends, according to the allocated channel resource, a sending acknowledgement message to the station that sends the received sending request message, so that stations that receive the sending acknowledgement message use channel resources to concurrently send uplink data. Therefore, a synchronization requirement that multiple stations use different subcarriers to concurrently send data can be well met.

FIG. 10 is a schematic structural diagram of Embodiment 1 of a station according to the present invention. As shown in FIG. 10, the station of this embodiment may include: a receiving module 21, a processing module 23, and a sending module 22, where the receiving module 21 is configured to receive channel opportunity information sent by an access point, where the channel opportunity information includes at least one channel opportunity, and the channel opportunity is a subchannel that can be used by the station to send a sending request message to the access point, and a corresponding subchannel usage time; the processing module 23 is configured to randomly select a channel opportunity from the channel opportunity information; and the sending module 22 is configured to send a sending request message to the access point by using the selected channel opportunity, so that the access point allocates, according to the received sending request message, to the station that sends the received sending request message, a channel resource that is used for sending uplink data, and sends, according to the allocated channel resource, a sending acknowledgement message to the station that sends the received sending request message, where the sending module 22 is further configured to send uplink data by using the allocated channel resource after receiving the sending acknowledgement message.

Further, the receiving, by the receiving module 21, channel opportunity information sent by an access point includes:

receiving, by the receiving module 21, a beacon frame sent by the access point, where the beacon frame includes the channel opportunity information; or receiving an uplink synchronization indication message sent by the access point, where the uplink synchronization indication message includes the channel opportunity information, where the uplink synchronization indication message may be a CTS frame.

Further, the receiving module 21 is further configured to:

before receiving the uplink synchronization indication message sent by the access point, receive a beacon frame sent by the access point, where the beacon frame includes information about a sending time at which the access point sends the uplink synchronization indication message within a current beacon period; and

maintain an awake state at the time at which the uplink synchronization indication message is sent, and receive the uplink synchronization indication message that is sent by the access point at the sending time.

In an implementable manner, the uplink synchronization indication message further includes station indication information, where the station indication information includes an identifier of a station that is allowed to send a sending request message, and the processing module 23 is further configured to:

after the receiving module receives the uplink synchronization indication message sent by the access point, determine, according to the station indication information, that the sending request message can be sent to the access point.

In the foregoing embodiment, in an implementable manner, the sending request message includes channel usage time information that is needed to send uplink data by the station that sends the sending request message or volume information of uplink data to be sent by the station that sends the sending request message, so that the access point allocates, according to the channel usage time information that is needed by the station to send the uplink data or the volume information of the uplink data to be sent by the station, where the information is included in the received sending request message, to the station that sends the received sending request message, a subchannel used for sending uplink data, and sends, by using the allocated subchannel, the sending acknowledgement message to the station that sends the received sending request message.

In another implementable manner, the sending request message includes subchannel indication information that is used to send uplink data by the station that sends the sending request message, so that the access point allocates, according to the subchannel indication information included in the received sending request message, one or more subchannels that are used for sending uplink data, and a corresponding channel usage time to the station that sends the received sending request message, and sends the sending acknowledgement message to the station by using the one or more subchannels that are used for sending uplink data and that are allocated to the station that sends the received sending request message, where the sending acknowledgement message includes the one or more subchannels that are used for sending uplink data and that are allocated to the station that sends the received sending request message, and the corresponding channel usage time.

Further, a transmit address field of the sending request message includes association identifier information of the station that sends the sending request message, and the subchannel indication information.

Further, a receive address field of the sending acknowledgement message includes association identifier information of the station that receives the sending acknowledgement message, one or more subchannels that are used for sending uplink data and that are allocated by the access point to the station, and corresponding channel usage time information.

In the foregoing embodiment, a duration field of the sending request message includes at least a channel usage time that is needed to send uplink data by the station that has data to be sent, so that another station that receives the sending request message sets a network allocation vector time value according to the channel usage time, and no longer contends for a channel within a corresponding network allocation vector time.

In the foregoing embodiment, further, the receiving module 21 is further configured to receive an acknowledgement message that is sent by the access point after the access point receives the uplink data.

The station of this embodiment may be used for performing the technical solution of the method embodiment shown in FIG. 2, and an implementation principle and a technical effect thereof are similar, which are not described herein again.

According to the station provided in this embodiment, a receiving module receives channel opportunity information sent by an access point; a sending module randomly selects a channel opportunity from the channel opportunity information, and sends a sending request message to the access point, so that the access point allocates, to the station according to the received sending request message, a channel resource that is used for sending uplink data, and sends a sending acknowledgement message to the station according to the allocated channel resource; and the receiving module uses, after receiving the sending acknowledgement message, the allocated channel resource to send uplink data. Therefore, a synchronization requirement that multiple stations use different subcarriers to concurrently send data can be well met.

A communications system provided in an embodiment of the present invention includes the access point shown in FIG. 9 and the station shown in FIG. 10.

FIG. 11 is a schematic structural diagram of Embodiment 2 of an access point according to the present invention. As shown in FIG. 11, the access point of this embodiment may include: a transmitter 31, a receiver 32, and a processor 33, where the transmitter 31 is configured to send channel opportunity information, where the channel opportunity information includes at least one channel opportunity, and the channel opportunity is a subchannel that can be used by a station to send a sending request message to the access point, and a corresponding subchannel usage time; the receiver 32 is configured to receive the sending request message sent by the station; and the processor 33 is configured to allocate, according to the sending request message, to the station that sends the received sending request message, a channel resource that is used for sending uplink data, where the transmitter 31 is further configured to send, according to the allocated channel resource, a sending acknowledgement message to the station that sends the received sending request message, so that stations that receive the sending acknowledgement message use channel resources to concurrently send uplink data.

Further, the sending, by the transmitter 31, channel opportunity information includes:

sending, by the transmitter 31, a beacon frame, where the beacon frame includes the channel opportunity information; or sending an uplink synchronization indication message, where the uplink synchronization indication message includes the channel opportunity information, where the uplink synchronization indication message may be a CTS frame.

Further, before sending the uplink synchronization indication message, the transmitter 31 is further configured to: send a beacon frame, where the beacon frame includes information about a sending time point at which the access point sends the uplink synchronization indication message within a current beacon period, so that a station that has data to be sent maintains an awake state at the time point at which the uplink synchronization indication message is sent, and receives the uplink synchronization indication message.

In an implementable manner, the uplink synchronization indication message may further include station indication information, where the station indication information includes an identifier of a station that is allowed to send a sending request message, and the station indication information is used by a station that has data to be sent, to determine, after receiving the uplink synchronization indication message, that a sending request message can be sent to the access point.

In the foregoing embodiment, in an implementable manner, the sending request message includes channel usage time information that is needed to send uplink data by the station that sends the sending request message or volume information of uplink data to be sent by the station that sends the sending request message, and the allocating, by the processor 33 according to the received sending request message, to the station that sends the received sending request message, a channel resource that is used for sending uplink data includes:

allocating, by the processor 33 according to the channel usage time information that is needed by the station to send the uplink data or the volume information of the uplink data to be sent by the station, where the information is included in the received sending request message, to the station that sends the received sending request message, a subchannel used for sending uplink data; and

the sending, by the transmitter 31 according to the allocated channel resource, a sending acknowledgement message to the station that sends the received sending request message includes:

sending, by the transmitter 31 by using the subchannel allocated to the station, the sending acknowledgement message to the station that sends the received sending request message.

In another implementable manner, the sending request message includes subchannel indication information that is used by the station to send uplink data, and the allocating, by the processor 33 according to the received sending request message, to the station that sends the received sending request message, a channel resource that is used for sending uplink data includes:

allocating, by the processor 33 according to the received sending request message, one or more subchannels that are used for sending uplink data, and a corresponding channel usage time to the station that sends the received sending request message; and

the sending, by the transmitter 31 according to the allocated channel resource, a sending acknowledgement message to the station that sends the received sending request message includes:

sending, by the transmitter 31 by using the one or more subchannels that are used for sending uplink data and that are allocated to the station, the sending acknowledgement message to the station that sends the received sending request message, where the sending acknowledgement message includes the one or more subchannels that are used for sending uplink data and that are allocated to the station, and the corresponding channel usage time. In another implementable manner, the allocating, by the processor 33 according to the received sending request message, to the station that sends the received sending request message, a channel resource that is used for sending uplink data includes:

allocating, by the processor 33 according to the subchannel indication information included in the received sending request message, to the station that sends the received sending request message, one or more subchannels that are used for sending uplink data, and a corresponding channel usage time; and

the sending, by the transmitter 31 according to the allocated channel resource, a sending acknowledgement message to the station that sends the received sending request message includes:

sending, by the transmitter 31 by using the one or more subchannels that are used for sending uplink data and that are allocated to the station, the sending acknowledgement message to the station that sends the received sending request message, where the sending acknowledgement message includes the one or more subchannels that are used for sending uplink data and that are allocated to the station, and the corresponding channel usage time. Further, a transmit address field of the sending request message includes association identifier information of the station that can send the sending request message, and the subchannel indication information.

A receive address field of the sending acknowledgement message includes association identifier information of the station that receives the sending acknowledgement message, one or more subchannels that are used for sending uplink data and that are allocated by the access point to the station that receives the sending acknowledgement message, and a corresponding channel usage time; one or more subchannels that are used for sending uplink data and that are allocated by the access point to the station, and corresponding channel usage time information.

In the foregoing embodiment, further, a duration field of the sending request message includes at least a channel usage time that is needed to send uplink data by the station that has data to be sent, so that another station that receives the sending request message sets a network allocation vector time value according to the channel usage time, and no longer contends for a channel within a corresponding network allocation vector time.

In the foregoing embodiment, further, the transmitter 31 is further configured to:

after the receiver 32 receives the uplink data sent by the station, concurrently send an acknowledgement message to stations that successfully send the uplink data.

The concurrently sending, by the transmitter 31, an acknowledgement message to stations that send the received uplink data includes:

concurrently sending, by the transmitter 31, on one of subchannels used when the station sends the uplink data, or on a corresponding subchannel on which the station sends the sending request message, the acknowledgement message to the stations that send the received uplink data.

The access point of this embodiment may be used for performing the technical solution of the method embodiment shown in FIG. 1, and an implementation principle thereof is similar, which is not described herein again.

According to the access point provided in this embodiment, a transmitter sends channel opportunity information, so that stations that have data to be sent randomly select, after receiving the channel opportunity information, a channel opportunity from the channel opportunity information, and concurrently send a sending request message to the access point; then a processor allocates, according to the sending request message received by a receiver, to a station that sends the received sending request message, a channel resource that is used for sending uplink data; and finally, the transmitter sends, according to the allocated channel resource, a sending acknowledgement message to the station that sends the received sending request message, so that stations that receive the sending acknowledgement message use channel resources to concurrently send uplink data. Therefore, a synchronization requirement that multiple stations use different subcarriers to concurrently send data can be well met.

FIG. 12 is a schematic structural diagram of Embodiment 2 of a station according to the present invention. As shown in FIG. 12, the station of this embodiment may include: a receiver 41, a processor 43, and a transmitter 42, where the receiver 41 is configured to receive channel opportunity information sent by an access point, where the channel opportunity information includes at least one channel opportunity, and the channel opportunity is a subchannel that can be used by the station to send a sending request message to the access point, and a corresponding subchannel usage time; the processor 43 is configured to randomly select a channel opportunity from the channel opportunity information; and the transmitter 42 is configured to send a sending request message to the access point by using the selected channel opportunity, so that the access point allocates, according to the received sending request message, to the station that sends the received sending request message, a channel resource that is used for sending uplink data, and sends, according to the allocated channel resource, a sending acknowledgement message to the station that sends the received sending request message, where the transmitter 42 is further configured to send uplink data by using the allocated channel resource after receiving the sending acknowledgement message.

Further, the receiving, by the receiver 41, channel opportunity information sent by an access point includes:

receiving, by the receiver 41, a beacon frame sent by the access point, where the beacon frame includes the channel opportunity information; or receiving an uplink synchronization indication message sent by the access point, where the uplink synchronization indication message includes the channel opportunity information, where the uplink synchronization indication message may be a CTS frame.

Further, the receiver 41 is further configured to:

before receiving the uplink synchronization indication message sent by the access point, receive a beacon frame sent by the access point, where the beacon frame includes information about a sending time point at which the access point sends the uplink synchronization indication message within a current beacon period; and

maintain an awake state at the time point at which the uplink synchronization indication message is sent, and receive the uplink synchronization indication message that is sent by the access point at the sending time point.

In an implementable manner, the uplink synchronization indication message further includes station indication information, where the station indication information includes an identifier of a station that is allowed to send a sending request message, and the processor 43 is further configured to:

after the receiving module receives the uplink synchronization indication message sent by the access point, determine, according to the station indication information, that the sending request message can be sent to the access point.

In the foregoing embodiment, in an implementable manner, the sending request message includes channel usage time information that is needed to send uplink data by the station that sends the sending request message or volume information of uplink data to be sent by the station that sends the sending request message, so that the access point allocates, according to the channel usage time information that is needed by the station to send the uplink data or the volume information of the uplink data to be sent by the station, where the information is included in the received sending request message, to the station that sends the received sending request message, a subchannel used for sending uplink data, and sends, by using the allocated subchannel, the sending acknowledgement message to the station that sends the received sending request message.

In another implementable manner, the sending request message includes subchannel indication information that is used to send uplink data by the station that sends the sending request message, so that the access point allocates, according to the subchannel indication information included in the received sending request message, one or more subchannels that are used for sending uplink data, and a corresponding channel usage time to the station that sends the received sending request message, and sends the sending acknowledgement message to the station by using the one or more subchannels that are used for sending uplink data and that are allocated to the station that sends the received sending request message, where the sending acknowledgement message includes the one or more subchannels that are used for sending uplink data and that are allocated to the station that sends the received sending request message, and the corresponding channel usage time.

Further, a transmit address field of the sending request message includes association identifier information of the station that sends the sending request message, and the subchannel indication information.

Further, a receive address field of the sending acknowledgement message includes association identifier information of the station that receives the sending acknowledgement message, one or more subchannels that are used for sending uplink data and that are allocated by the access point to the station, and a corresponding channel usage time; one or more subchannels that are used for sending uplink data and that are allocated by the access point to the station, and corresponding channel usage time information.

In the foregoing embodiment, a duration field of the sending request message includes at least a channel usage time that is needed to send uplink data by the station that has data to be sent, so that another station that receives the sending request message sets a network allocation vector time value according to the channel usage time, and no longer contends for a channel within a corresponding network allocation vector time.

In the foregoing embodiment, further, the receiver 41 is further configured to receive an acknowledgement message that is sent by the access point after the access point receives the uplink data.

The station of this embodiment may be used for performing the technical solution of the method embodiment shown in FIG. 2, and an implementation principle and a technical effect thereof are similar, which are not described herein again.

According to the station provided in this embodiment, a receiver receives channel opportunity information sent by an access point; a transmitter randomly selects a channel opportunity from the channel opportunity information, and sends a sending request message to the access point, so that the access point allocates, to the station according to the received sending request message, a channel resource that is used for sending uplink data, and sends a sending acknowledgement message to the station according to the allocated channel resource; and the receiver uses, after receiving the sending acknowledgement message, the allocated channel resource to send uplink data. Therefore, a synchronization requirement that multiple stations use different subcarriers to concurrently send data can be well met.

A communications system provided in an embodiment of the present invention includes the access point shown in FIG. 11 and the station shown in FIG. 12.

Persons of ordinary skill in the art may understand that all or some of the steps of the method embodiments may be implemented by a program instructing relevant hardware. The program may be stored in a computer-readable storage medium. When the program runs, the steps of the method embodiments are performed. The foregoing storage medium includes: any medium that can store program code, such as a ROM, a RAM, a magnetic disc, or an optical disc.

Finally, it should be noted that the foregoing embodiments are merely intended for describing the technical solutions of the present invention, but not for limiting the present invention. Although the present invention is described in detail with reference to the foregoing embodiments, persons of ordinary skill in the art should understand that they may still make modifications to the technical solutions described in the foregoing embodiments or make equivalent replacements to some or all technical features thereof, without departing from the scope of the technical solutions of the embodiments of the present invention.

1. A data transmission method, comprising:
sending, by an access point, channel opportunity information, wherein the channel opportunity information comprises at least one channel opportunity, and the channel opportunity is a subchannel that can be used by a station to send a sending request message to the access point, and a corresponding subchannel usage time;
allocating, by the access point according to the received sending request message, to the station that sends the received sending request message, a channel resource that is used for sending uplink data; and
sending, by the access point according to the allocated channel resource, a sending acknowledgement message to the station that sends the received sending request message, so that stations that receive the sending acknowledgement message use the channel resource to concurrently send uplink data.

2. The method according to claim 1, wherein the sending, by an access point, channel opportunity information comprises:
sending, by the access point, a beacon frame, wherein the beacon frame comprises the channel opportunity information.

3. The method according to claim 1, wherein the sending, by an access point, channel opportunity information comprises:
sending, by the access point, an uplink synchronization indication message, wherein the uplink synchronization indication message comprises the channel opportunity information.

4. The method according to claim 3, before the sending, by the access point, an uplink synchronization indication message, further comprising:
sending, by the access point, a beacon frame, wherein the beacon frame comprises a sending time at which the access point sends the uplink synchronization indication message within a current beacon period, so that a station that has data to be sent maintains an awake state at the time at which the uplink synchronization indication message is sent, and receives the uplink synchronization indication message.

5. The method according to claim 3, wherein the uplink synchronization indication message further comprises station indication information, wherein the station indication information comprises an identifier of a station that is allowed to send a sending request message, and the station indication information is used by a station that has data to be sent, to determine, after receiving the uplink synchronization indication message, that a sending request message can be sent to the access point.

6. The method according to claim 1, wherein the sending request message comprises channel usage time information that is needed to send uplink data by the station that sends the sending request message or volume information of uplink data to be sent by the station that sends the sending request message, and the allocating, by the access point according to the received sending request message, to the station that sends the received sending request message, a channel resource that is used for sending uplink data comprises:
allocating, by the access point according to the channel usage time information that is needed by the station to send the uplink data or the volume information of the uplink data to be sent by the station, wherein the information is comprised in the received sending request message, to the station that sends the received sending request message, a subchannel used for sending uplink data; and
the sending, by the access point according to the allocated channel resource, a sending acknowledgement message to the station that sends the received sending request message comprises:
sending, by the access point by using the subchannel allocated to the station, the sending acknowledgement message to the station that sends the received sending request message.

7. The method according to claim 1, wherein the allocating, by the access point according to the received sending request message, to the station that sends the received sending request message, a channel resource that is used for sending uplink data comprises:
allocating, by the access point according to the received sending request message, one or more subchannels that are used for sending uplink data, and a corresponding channel usage time to the station that sends the received sending request message; and
the sending, by the access point according to the allocated channel resource, a sending acknowledgement message to the station that sends the received sending request message comprises:
sending, by the access point by using the one or more subchannels that are used for sending uplink data and that are allocated to the station that sends the received sending request message, the sending acknowledgement message to the station that sends the received sending request message, wherein the sending acknowledgement message comprises the one or more subchannels that are used for sending uplink data and that are allocated to the station that sends the received sending request message, and the corresponding channel usage time.

8-48. (canceled)

49. An access point, comprising:
a transmitter, configured to send channel opportunity information, wherein the channel opportunity information comprises at least one channel opportunity, and the channel opportunity is a subchannel that can be used by a station to send a sending request message to the access point, and a corresponding subchannel usage time;
a receiver, configured to receive the sending request message sent by the station; and
a processor, configured to allocate, according to the received sending request message, to the station that sends the received sending request message, a channel resource that is used for sending uplink data, wherein
the transmitter is further configured to send, according to the allocated channel resource, a sending acknowledgement message to the station that sends the received sending request message, so that stations that receive the sending acknowledgement message use the channel resource to concurrently send uplink data.

50. The access point according to claim 49, wherein the sending channel opportunity information comprises:
sending a beacon frame, wherein the beacon frame comprises the channel opportunity information.

51. The access point according to claim 49, wherein the sending channel opportunity information comprises:
sending an uplink synchronization indication message, wherein the uplink synchronization indication message comprises the channel opportunity information.

52. The access point according to claim 51, wherein before sending the uplink synchronization indication message, the transmitter is further configured to:
send a beacon frame, wherein the beacon frame comprises a sending time at which the access point sends the uplink synchronization indication message within a current beacon period, so that a station that has data to be sent maintains an awake state at the time at which the uplink synchronization indication message is sent, and receives the uplink synchronization indication message.

53. The access point according to claim 51 or 52, wherein the uplink synchronization indication message further comprises station indication information, wherein the station indication information comprises an identifier of a station that is allowed to send a sending request message, and the station indication information is used by a station that has data to be sent, to determine, after receiving the uplink synchronization indication message, that a sending request message can be sent to the access point.

54. The access point according to claim 49, wherein the sending request message comprises channel usage time information that is needed to send uplink data by the station that sends the sending request message or volume information of uplink data to be sent by the station that sends the sending request message, and the allocating, according to the received sending request message, to the station that sends the received sending request message, a channel resource that is used for sending uplink data comprises:
allocating, according to the channel usage time information that is needed by the station to send the uplink data or the volume information of the uplink data to be sent by the station, wherein the information is comprised in the received sending request message, to the station that sends the received sending request message, a subchannel used for sending uplink data; and
the sending, according to the allocated channel resource, a sending acknowledgement message to the station that sends the received sending request message comprises:
sending, by using the subchannel allocated to the station, the sending acknowledgement message to the station that sends the received sending request message.

55-61. (canceled)

62. A station, comprising:
a receiver, configured to receive channel opportunity information sent by an access point, wherein the channel opportunity information comprises at least one channel opportunity, and the channel opportunity is a subchannel that can be used by the station to send a sending request message to the access point, and a corresponding subchannel usage time;
a processor, configured to randomly select a channel opportunity from the channel opportunity information; and
a transmitter, configured to send a sending request message to the access point by using the selected channel opportunity, so that the access point allocates, according to the received sending request message, to the station that sends the received sending request message, a channel resource that is used for sending uplink data, and sends, according to the allocated channel resource, a sending acknowledgement message to the station that sends the received sending request message, wherein
the transmitter is further configured to send uplink data by using the allocated channel resource after receiving the sending acknowledgement message.

63. The station according to claim 62, wherein the receiving channel opportunity information sent by an access point comprises:
receiving a beacon frame sent by the access point, wherein the beacon frame comprises the channel opportunity information.

64. The station according to claim 62, wherein the receiving channel opportunity information sent by an access point comprises:
receiving an uplink synchronization indication message sent by the access point, wherein the uplink synchronization indication message comprises the channel opportunity information.

65. The station according to claim 64, wherein the receiver is further configured to:
before receiving the uplink synchronization indication message sent by the access point, receive a beacon frame sent by the access point, wherein the beacon frame comprises a sending time at which the access point sends the uplink synchronization indication message within a current beacon period; and
maintain an awake state at the time at which the uplink synchronization indication message is sent, and receive the uplink synchronization indication message that is sent by the access point at the sending time.

66. The station according to claim 64, wherein the uplink synchronization indication message further comprises station indication information, wherein the station indication information comprises an identifier of a station that is allowed to send a sending request message, and the processor is further configured to:
after the receiver receives the uplink synchronization indication message sent by the access point, determine, according to the station indication information, that the sending request message can be sent to the access point; and
the randomly selecting a channel opportunity from the channel opportunity information, and sending the sending request message to the access point specifically comprises:
after the processor determines that the sending request message can be sent to the access point, randomly selecting a channel opportunity from the channel opportunity information, and sending the sending request message to the access point.

67. The station according to claim 62, wherein the sending request message comprises channel usage time information that is needed to send uplink data by the station that sends the sending request message or volume information of uplink data to be sent by the station that sends the sending request message, so that the access point allocates, according to the channel usage time information that is needed by the station to send the uplink data or the volume information of the uplink data to be sent by the station, wherein the information is comprised in the received sending request message, to the station that sends the received sending request message, a subchannel used for sending uplink data, and sends, by using the allocated subchannel, the sending acknowledgement message to the station that sends the received sending request message.

68. The station according to claim 62, wherein the sending request message comprises subchannel indication information that is used to send uplink data by the station that sends the sending request message, so that the access point allocates, according to the subchannel indication information comprised in the received sending request message, one or more subchannels that are used for sending uplink data, and a corresponding channel usage time to the station that sends the received sending request message, and sends the sending acknowledgement message to the station by using the one or more subchannels that are used for sending uplink data and that are allocated to the station that sends the received sending request message, wherein the sending acknowledgement message comprises the one or more subchannels that are used for sending uplink data and that are allocated to the station that sends the received sending request message, and the corresponding channel usage time.

69-72. (canceled)
